(19) United States
(12) Patent Application Publication
(10) Pub. No.: US 2019/0211921 A1
(43) Pub. Date: Jul. 11, 2019

(54) SHIFT DEVICE

(71) Applicant: KABUSHIKI KAISHA TOKAI-RIKA-DENKI-SEISAKUSHO, Niwa-gun (JP)

(72) Inventors: Tomoki WATANABE, Aichi-ken (JP); Yoshinobu YOKOYAMA, Aichi-ken (JP); Kunihiro MORIMURA, Plymouth, MI (US)

(21) Appl. No.: 15/862,656

(22) Filed: Jan. 5, 2018

(51) Int. Cl. F16H 61/22; F16H 59/08

(52) U.S. Cl. CPC F16H 61/22; F16H 2059/081; F16H 2061/223; F16H 59/08

(57) ABSTRACT

In a shift device, when rotation of a knob away from a P position is locked or unlocked by movement of a lock body, a corner portion of a pinion tooth of a pinion slides against a front face of a rack tooth of the lock body, thereby moving the lock body. It is therefore possible to reduce a disparity between the movement speed of the lock body and the rotation speed of the pinion, thereby enabling the movement time of the lock body to be easily controlled.

### BACKGROUND

### Technical Field

The present invention relates to a shift device in which a shift body is moved to change a shift position of the shift body.

### Related Art

In a shifting device described in US2016/0238128A1, a locking element is moved from a first position to a second position and engaged with a locking contour of an operation element, thereby restricting rotation of the operation element away from a P position. Moreover, the locking element is moved from the second position to the first position to release the engagement of the operation element with the locking contour, thereby releasing the restriction of rotation of the operation element away from the P position.

In this shifting device, a protrusion of the locking element is engaged with a control contour of a set ring. The locking element is moved by rotating the set ring.

### SUMMARY

In consideration of the above circumstances, an object of the present invention is to obtain a shift device that enables easy control of the movement time of a restriction body.

A shift device of a first aspect of the present invention comprises a shift body that is moved to change a shift position; a restriction body that is moved to one side to restrict movement of the shift body away from a predetermined shift position, and that is moved to another side to release the restriction of movement of the shift body away from the predetermined shift position; and a moving gear that is capable of meshing with the restriction body, and that is rotated to move the restriction body.

In the shift device of the first aspect of the present invention, the shift body is moved to change the shift position of the shift body. Moreover, the restriction body is moved to one side to restrict movement of the shift body away from the predetermined shift position, and the restriction body is moved to the other side to release the restriction of movement of the shift body away from the predetermined shift position.

The restriction body and the moving gear are capable of meshing with each other. The moving gear is rotated to move the restriction body. This thereby enables a disparity between the rotation speed of the moving gear and the movement speed of the restriction body to be reduced, enabling the movement time of the restriction body to be easily controlled.

A shift device of a second aspect of the present invention is the shift device of the first aspect of the present invention, wherein the restriction body is retained when meshing between the restriction body and the moving gear has been released.

In the shift device of the second aspect of the present invention, the restriction body is retained when meshing between the restriction body and the moving gear has been released. This thereby enables unwanted movement of the restriction body to be restricted.

A shift device of a third aspect of the present invention is the shift device of the first aspect of the present invention, further including a guide portion that guides meshing between the restriction body and the moving gear.

In the shift device of the third aspect of the present invention, the guide portion guides meshing between the restriction body and the moving gear. This thereby enables appropriate meshing between the restriction body and the moving gear.

### BRIEF DESCRIPTION OF THE DRAWINGS

Exemplary embodiments of the present invention will be described in detail based on the following figures, wherein:

FIG. 1 is an exploded perspective view illustrating a knob and a rotor cam of a shift device according to an exemplary embodiment of the present invention, as viewed from a lower side;

FIG. 2 is a plan view illustrating relevant portions of the shift device according to the exemplary embodiment of the present invention, as viewed from above;

FIG. 3 is a plan view illustrating the shift device according to the exemplary embodiment of the present invention, as viewed from above in a state in which rotation of a knob away from a P position is restricted;

FIG. 4 is a plan view illustrating the shift device according to the exemplary embodiment of the present invention, as viewed from above in a state in which a knob is being rotation driven toward a P position; and

FIG. 5 is a cut-away perspective view illustrating relevant portions of the shift device according to the exemplary embodiment of the present invention, as viewed obliquely from the rear right.

### DETAILED DESCRIPTION

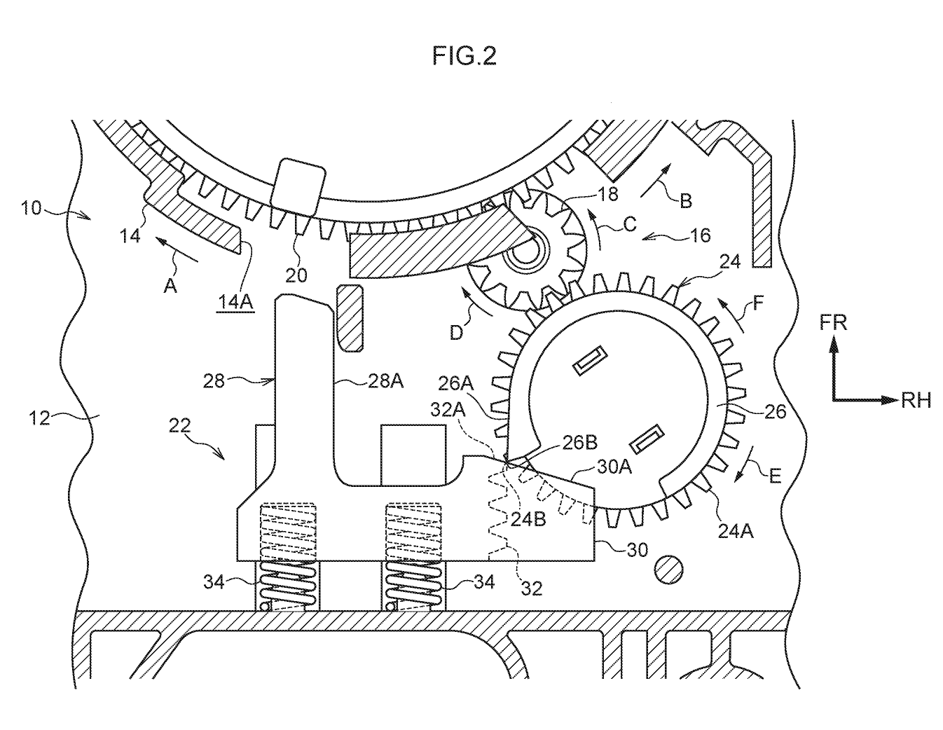

FIG. 2 is a plan view illustrating relevant portions of a shift device 10 according to an exemplary embodiment of the present invention, as viewed from above. Note that in the drawings, the front of the shift device 10 is indicated by the arrow FR, the right of the shift device 10 is indicated by the arrow RH, and the upper side of the shift device 10 is indicated by the arrow UP.

The shift device 10 according to the present exemplary embodiment is installed to a console (not illustrated in the drawings) of a vehicle (automobile), and is disposed at a vehicle front side and vehicle width direction inside of a driver's seat (not illustrated in the drawings) of the vehicle. The front, right, and upper side of the shift device 10 are respectively aligned with the front, right, and upper side of the vehicle.

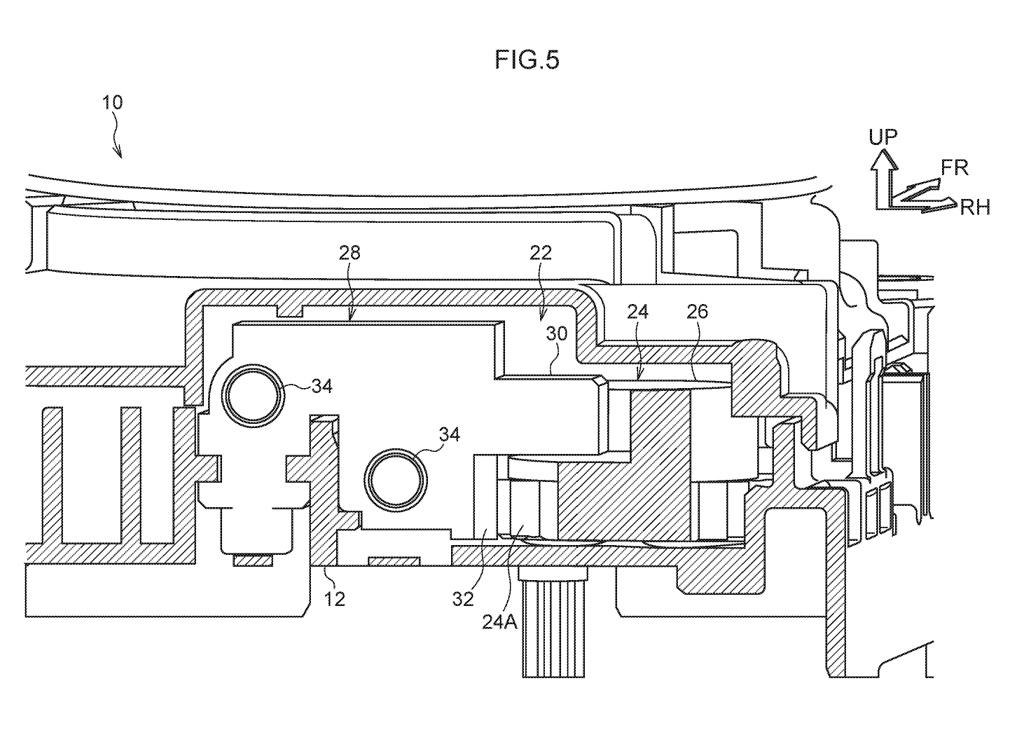

As illustrated in FIG. 2, the shift device 10 is provided with a substantially cuboidal box shaped plate 12 (see FIG. 5), serving as a support body. The plate 12 is installed inside the console.

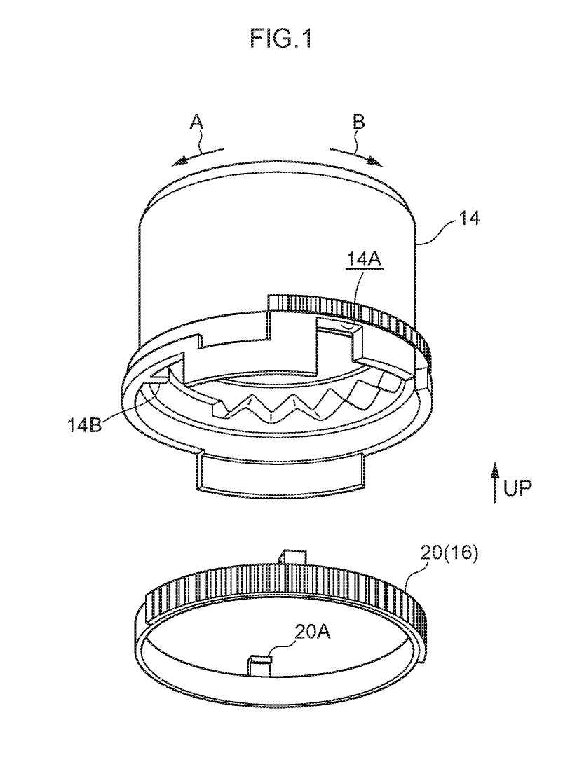

A knob 14 (see FIG. 1) having a substantially cylinder shape closed at one end, and serving as a shift body (operation body), is supported at an upper side of the plate 12 so as to be capable of rotating (moving) about the up-down direction. The inside of the knob 14 is open toward the lower side, and the knob 14 is exposed to the vehicle cabin interior through the console. The knob 14 is capable of being rotation operated over a predetermined range by an occupant of the vehicle in one direction (the arrow A direction in FIG. 1, etc.) and another direction (the arrow B direction in FIG. 1, etc.). The knob 14 can be disposed at a P position (parking position, predetermined shift position), an R position (reverse position), an N position (neutral position), and a D position (drive position), serving as shift positions in sequence from the other direction side toward the one direction side.

A rectangular lock hole 14A, serving as a restricted portion, is formed penetrating a lower end portion of a circumferential wall of the knob 14. The lock hole 14A is open toward the lower side. At the lower end portion of the circumferential wall of the knob 14, a rectangular plate shaped rotation plate 14B, serving as a driven portion, is integrally provided on the one direction side of the lock hole 14A. The rotation plate 14B projects toward the radial direction inside of the knob 14.

A drive mechanism 16 is installed to the plate 12. The drive mechanism 16 is electrically connected to a control device (not illustrated in the drawings). A vehicle brake (not illustrated in the drawings) is also electrically connected to the control device. The vehicle brakes when the occupant engages the brake.

The drive mechanism 16 is provided with a drive gear 18. The drive gear 18 is supported at the rear side and right side of the knob 14 so as to be capable of rotating about the up-down direction at the upper side of the plate 12. Rotation of the drive gear 18 is restricted, and the drive gear 18 is rotated in a forward direction (the arrow C direction in FIG. 2, etc.) or a reverse direction (the arrow D direction in FIG. 2, etc.) when the drive mechanism 16 is actuated forward or actuated in reverse, respectively.

The drive mechanism 16 is provided with an annular rotor cam 20 (see FIG. 1), serving as a drive member. The rotor cam 20 is supported at the upper side of the plate 12 so as to be capable of rotating about the up-down direction. The rotor cam 20 is disposed coaxially to the knob 14 at the lower side of the knob 14, with a rotation position of the rotor cam 20 disposed at a reference position (start position). The rotor cam 20 is integrally provided with a plate shaped drive plate 20A, that serves as a drive section and has a substantially L-shaped cross-section profile. The drive plate 20A projects toward the upper side. The drive plate 20A is separated from the rotation plate 14B of the knob 14 toward the one direction side, such that the rotation plate 14B is not capable of abutting the drive plate 20A when the knob 14 is rotated from the P position to the D position. The drive gear 18 meshes with the outer circumference of the rotor cam 20, such that when the drive gear 18 is rotated in the forward direction, the rotor cam 20 is rotated in the one direction, and when the drive gear 18 is rotated in the reverse direction, the rotor cam 20 is rotated in the other direction.

At a rear side of the knob 14, a lock mechanism 22, serving as a restriction mechanism, is installed to the plate 12.

The lock mechanism 22 is provided with a pinion 24 (see FIG. 5), serving as a moving gear. The pinion 24 is supported at the upper side of the plate 12 so as to be capable of rotating about the up-down direction. Trapezoidal column shaped pinion teeth 24A, serving as gear teeth, are provided to the outer circumference of a lower-side portion of the pinion 24. The pinion teeth 24A are disposed at a uniform spacing around the circumferential direction of the pinion 24, and mesh with the drive gear 18. Accordingly, when the drive gear 18 is rotated in the forward direction, the pinion 24 is rotated in a locking direction (restriction direction, the arrow E direction in FIG. 2, etc.), and when the drive gear 18 is rotated in the reverse direction, the pinion 24 is rotated in a release direction (the arrow F direction in FIG. 2, etc.).

A retention frame 26, that serves as a retention portion and has a C-shaped frame shape in plan view, is provided at an upper-side portion of the pinion 24. With the exception of a release-direction-side end portion of the retention frame 26, the outer periphery of the retention frame 26 is disposed aligned with the positions of radial direction base ends of the pinion teeth 24A of the pinion 24. A guide projection 26A, serving as a guide portion, is formed to the outer periphery of the release direction side end portion of the retention frame 26. The guide projection 26A projects toward the radial direction outside of the pinion 24, and the projection amount of the guide projection 26A toward the radial direction outside of the pinion 24 increases on progression along the release direction. A release direction side end face of the guide projection 26A is in the same plane as a release direction side end face of the pinion tooth 24A positioned at the lower side thereof, and a corner portion 26B of the guide projection 26A on the radial direction outside and release direction side of the pinion 24 is disposed nearly above a corner portion 24B on a leading end side and release direction side of the pinion tooth 24A at the lower side.

The lock mechanism 22 is provided with a lock body 28 (see FIG. 5) that serves as a restriction body and has a substantially L-shaped block shape in plan view. The lock body 28 is supported at the upper side of the plate 12 so as to be capable of moving in the front-rear direction, while movement of the lock body 28 in the left-right direction and the up-down direction is restricted.

A trapezoidal column shaped actuation portion 30 is provided at an upper side portion of a right end portion of the lock body 28. A front face 30A of the actuation portion 30 is inclined in a direction toward the rear side on progression toward the right side, and the actuation portion 30 is inserted between the two circumferential direction ends of the retention frame 26 of the pinion 24. The right end portion of the lock body 28 is provided with truncated columnar rack teeth 32, serving as moving teeth, at the lower side of a left end portion of the actuation portion 30. The rack teeth 32 are disposed at a uniform spacing in the front-rear direction. The placement spacing between the rack teeth 32 in the front-rear direction is the same as the placement spacing between the pinion teeth 24A around the circumferential direction of the pinion 24. A front face 32A of a front end rack tooth 32 is disposed in the same plane as the front face 30A of the actuation portion 30. A rectangular columnar lock bar 28A serving as a restriction portion is provided at the left end portion of the lock body 28. The lock bar 28A extends toward the front.

A predetermined number (two in the present exemplary embodiment) of springs 34 (compression coil springs), serving as urging members, are provided at the rear side of the lock body 28. The springs 34 span between the lock body 28 and the plate 12, and urge the lock body 28 toward the front side. The front face 32A of the rack tooth 32 of the lock body 28 is abutted against (meshed with) the corner portion 24B of the pinion tooth 24A of the pinion 24 under the urging force of the springs 34, such that the front face 30A of the actuation portion 30 of the lock body 28 is separated slightly from the corner portion 26B of the guide projection 26A of the pinion 24. The lock body 28 is disposed at a rear side position, with the lock bar 28A disposed at the rear side of the knob 14 (see FIG. 2).

Next, explanation follows regarding operation of the present exemplary embodiment.

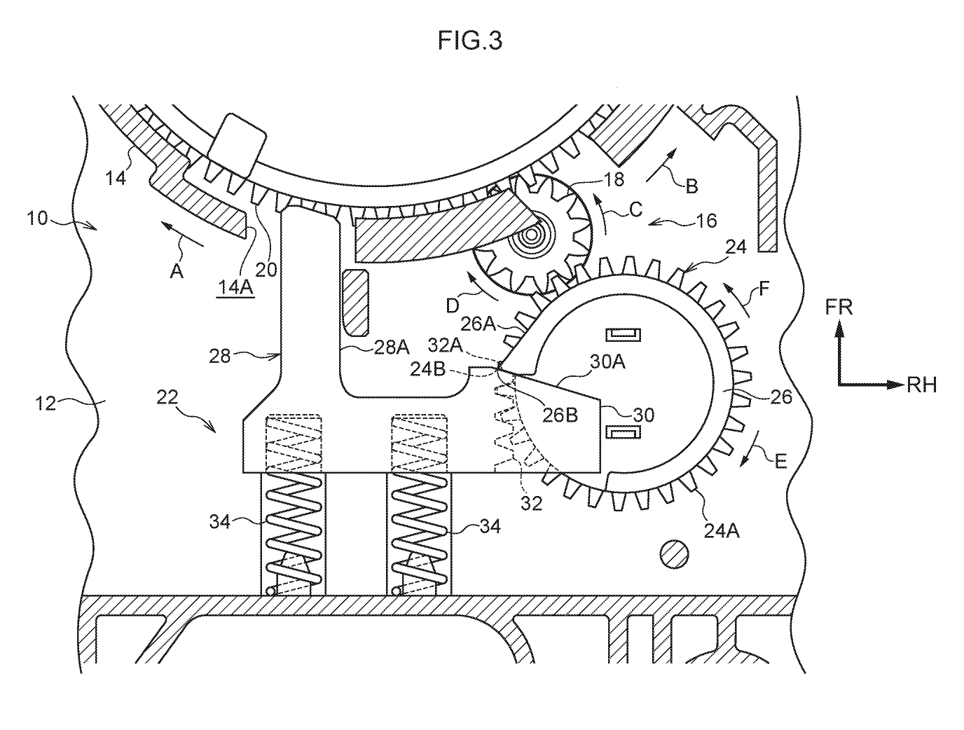

In the shift device 10 configured as described above, in cases in which the knob 14 has been disposed at the P position and the brake is not being engaged, the drive mechanism 16 is driven forward under the control of the control device, thereby rotating the drive gear 18 in the forward direction (arrow C direction), such that the pinion 24 (including the guide projection 26A) is rotated in the locking direction (arrow E direction) in the lock mechanism 22. Accordingly, the corner portion 24B of the pinion tooth 24A of the pinion 24 slides against the front face 32A of the rack tooth 32 of the lock body 28 toward the left side (the pinion tooth 24A is meshed with the rack tooth 32), in a state in which the guide projection 26A is separated from the front face 30A of the actuation portion 30 of the lock body 28, and the lock body 28 is moved toward the front side (one side and restriction side) under the urging force of the springs 34 (see FIG. 3). Accordingly, the lock bar 28A of the lock body 28 is inserted into the lock hole 14A of the knob 14, such that rotation of the knob 14 away from the P position toward the one direction (R position side) is locked (restricted) by the lock bar 28A.

On the other hand, in cases in which the knob 14 has been disposed at the P position and the brake is being engaged, the drive mechanism 16 is driven in reverse under the control of the control device, thereby rotating the drive gear 18 in the reverse direction (arrow D direction), such that the pinion 24 (including the guide projection 26A) of the lock mechanism 22 is rotated in the release direction (arrow F direction). Accordingly, the corner portion 24B of the pinion tooth 24A of the pinion 24 slides against the front face 32A of the rack tooth 32 of the lock body 28 toward the right side (the pinion tooth 24A is meshed with the rack tooth 32), in a state in which the guide projection 26A is separated from the front face 30A of the actuation portion 30 of the lock body 28, and the lock body 28 is moved toward the rear side (other side, release side) against the urging force of the springs 34 (see FIG. 2). The insertion of the lock bar 28A into the lock hole 14A is thereby released, unlocking rotation of the knob 14 away from the P position toward the one direction (R position side) by the lock bar 28A.

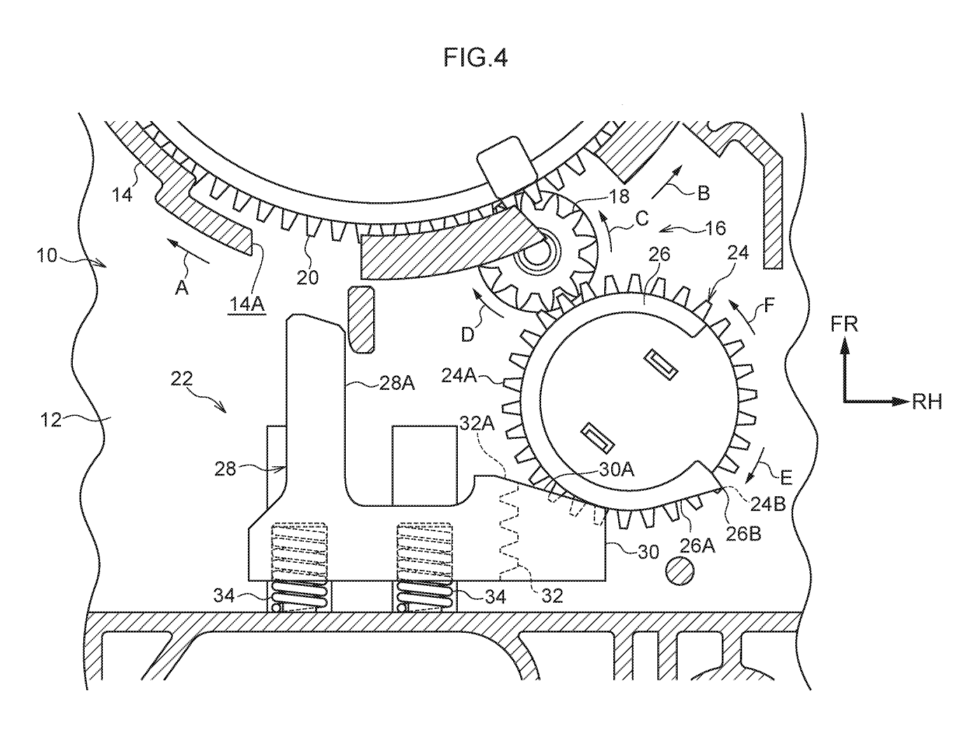

Moreover, when the knob 14 has been disposed at a position other than the P position (for example the R position, the N position, or the D position), on a predetermined occasion (for example when the engine of the vehicle has been turned OFF), the drive mechanism 16 is driven in reverse under the control of the control device, thereby rotating the drive gear 18 in the reverse direction (arrow D direction), such that the rotor cam 20 is rotated in the other direction (arrow B direction) and the pinion 24 (including the retention frame 26 and the guide projection 26A) of the lock mechanism 22 is rotated in the release direction (arrow F direction). Accordingly, the drive plate 20A of the rotor cam 20 is abutted against the rotation plate 14B of the knob 14 and rotates (drives) the knob 14 in the other direction as far as the P position, and the corner portion 26B of the guide projection 26A slides against the front face 30A of the actuation portion 30 of the lock body 28 toward the right side, and the outer periphery of the retention frame 26 (including the outer periphery of the guide projection 26A) slides against the front face 30A of the actuation portion 30 toward the right side (see FIG. 4).

Moreover, when the knob 14 has been rotated as far as the P position, the drive mechanism 16 is driven forward under the control of the control device, thereby rotating the drive gear 18 in the forward direction (arrow C direction), such that the rotor cam 20 is rotated in the one direction (arrow A direction) and the pinion 24 (including the retention frame 26 and the guide projection 26A) of the lock mechanism 22 is rotated in the locking direction (arrow E direction). Accordingly, the rotor cam 20 is rotated (returned) to the reference position. Moreover, the outer periphery of the retention frame 26 (including the outer periphery of the guide projection 26A) slides against the front face 30A of the actuation portion 30 of the lock body 28 toward the left side, and the corner portion 26B of the guide projection 26A slides against the front face 30A of the actuation portion 30 toward the left side Accordingly, the front face 32A of the rack tooth 32 of the lock body 28 is abutted against the corner portion 24B of the pinion tooth 24A of the pinion 24, and the front face 30A of the actuation portion 30 is separated slightly from the corner portion 26B of the guide projection 26A (see FIG. 2).

Note that when rotation of the knob 14 away from the P position is locked or unlocked by the movement of the lock body 28 (lock bar 28A), the corner portion 24B of the pinion tooth 24A of the pinion 24 slides against the front face 32A of the rack tooth 32 of the lock body 28, thereby moving the lock body 28 in the front-rear direction. It is therefore possible to reduce a disparity in the movement speed of the lock body 28 in the front-rear direction (the front-rear direction speed at the meshing position of the front face 32A of the rack tooth 32 with the corner portion 24B of the pinion tooth 24A) with respect to the rotation speed of the pinion 24 (the circumferential direction rotation speed at the meshing position of the corner portion 24B of the pinion tooth 24A and the front face 32A of the rack tooth 32), and the movement time of the lock body 28 can be easily controlled, enabling the time taken to lock or unlock rotation of the knob 14 away from the P position by moving the lock body 28 to be easily controlled.

Moreover, when the meshing between the lock body 28 (the front face 32A of the rack tooth 32) and the pinion 24 (the corner portion 24B of the pinion tooth 24A) has been released, the front face 30A of the actuation portion 30 of the lock body 28 is abutted against the corner portion 26B of the guide projection 26A and the outer periphery of the retention frame 26 of the pinion 24 (including the outer periphery of the guide projection 26A) under the urging force of the springs 34, thereby retaining the lock body 28 (see FIG. 4). This thereby enables unwanted movement of the lock body 28 to be restricted.

Moreover, the corner portion 26B of the guide projection 26A of the pinion 24 is disposed nearly above the corner portion 24B of one pinion tooth 24A of the pinion 24, and the front face 30A of the actuation portion 30 of the lock body 28 is in the same plane as the front face 32A of one rack tooth 32 of the lock body 28. When the pinion 24 is rotated in the locking direction (arrow E direction) after the rotor cam 20 rotates the knob 14 as far as the P position, the corner portion 26B of the guide projection 26A slides against the front face 30A of the actuation portion 30 toward the left side, thereby guiding the meshing of the corner portion 24B of the pinion tooth 24A with the front face 32A of the rack tooth 32. This thereby enables the pinion tooth 24A and the rack teeth 32 to be meshed together appropriately.

Note that in the present exemplary embodiment, the rack tooth 32 of the lock body 28 and the pinion tooth 24A of the pinion 24 are meshed together all the time when locking rotation of the knob 14 away from the P position by moving the lock body 28 toward the front side, and when unlocking rotation of the knob 14 away from the P position by moving the lock body 28 toward the rear side. However, it is sufficient that the rack tooth 32 of the lock body 28 and the pinion tooth 24A of the pinion 24 be meshed with each other at at least temporary time when locking rotation of the knob 14 away from the P position by moving the lock body 28 toward the front side, and when unlocking rotation of the knob 14 away from the P position by moving the lock body 28 toward the rear side.

Moreover, in the present exemplary embodiment, the lock body 28 locks rotation of the knob 14 away from the P position. However, the lock body 28 may lock rotation of the knob 14 away from a shift position other than the P position (for example the N position).

Moreover, in the present exemplary embodiment, the knob 14 (shift body) is rotation operated. However, the shift body may be pivot operated, or may be slide operated.

In the present exemplary embodiment, the shift device 10 is installed to the console. However, the shift device 10 may be installed to an instrument panel or to a column cover.

What is claimed is:

1. A shift device comprising:
a shift body that is moved to change a shift position;
a restriction body that is moved to one side to restrict movement of the shift body away from a predetermined shift position, and that is moved to another side to release the restriction of movement of the shift body away from the predetermined shift position; and
a moving gear that is capable of meshing with the restriction body, and that is rotated to move the restriction body.

2. The shift device of claim 1, wherein the restriction body is retained when meshing between the restriction body and the moving gear has been released.

3. The shift device of claim 1, further comprising a guide portion that guides meshing between the restriction body and the moving gear.
